(19) United States
(12) Patent Application Publication
(10) Pub. No.: US 2023/0093257 A1
(43) Pub. Date: Mar. 23, 2023

(54) OPTICAL SENSOR WITH CROSSTALK PREVENTION

(71) Applicant: Kohler Co., Kohler, WI (US)

(72) Inventors: Gabriel M. Niederlander, Wauwatosa, WI (US); Timothy J. Waack, Manitowoc, WI (US); John O. Lipinski, Sheboygan, WI (US); Govinda Rao Koyala, Sheboygan, WI (US)

(21) Appl. No.: 17/929,225

(22) Filed: Sep. 1, 2022

Related U.S. Application Data
(60) Provisional application No. 63/245,604, filed on Sep. 17, 2021.

(51) Int. Cl. G01S 7/481; G01S 17/04; G01S 17/08; E03C 1/05

(52) U.S. Cl. CPC G01S 7/4811; G01S 17/04; G01S 17/08; E03C 1/057

(57) ABSTRACT

A sensor system can include a housing and a lens carrier at least partially disposed within the housing. The lens carrier defines a cylindrical structure including a number of housings disposed at a midpoint of the lens carrier, the housings configured to hold a number of sensor assemblies therein. The sensor assemblies include a first sensor assembly positioned proximate a second sensor assembly, each including a sensor lens and a sensor. The first sensor assembly is configured to emit a signal and the second sensor assembly is configured to receive the emitted signal. Positioned between the first sensor assembly and the second sensor assembly, and at least partially disposed around each assembly, is a gasket. The gasket extends from a base of the first sensor and the second sensor to second face of the lens carrier, and is configured to block an emitted signal from the first sensor assembly.

### CROSS REFERENCE TO RELATED APPLICATIONS

The present application claims the benefit of U.S. Provisional Application No. 63/245,604, filed on Sep. 17, 2021, the disclosure of which is incorporated by reference herein.

### BACKGROUND

The present disclosure relates generally to a sensor system. More specifically, the present disclosure relates to a sensor system for use in home devices.

Traditionally, sensor systems have been subject to signal crosstalk between an emitting sensor and a receiving sensor. That is, the receiving sensor has traditionally received photons that were incidentally reflected prior to reaching a target object. Signal crosstalk affects a distance measurement where the recorded distance is closer than the target distance. Typically, signal crosstalk occurs at a lens surface, where the incident rays may both reflect and refract at, or within, the lens.

In bathroom or kitchen applications, condensation has been commonly known to increase the potential or severity of signal crosstalk, inadvertently leading to a false actuation of a device. To combat this issue, mechanical blockers may be used to obstruct the signal crosstalk such to minimize the potential for signal crosstalk to occur. However, the opportunity exists for additional improvements, especially with regard to crosstalk resulting from condensation. The present disclosure addresses these concerns.

### SUMMARY

At least one embodiment relates to a sensor system for use in home devices. The sensor system includes a housing and a lens carrier at least partially disposed within the housing. The lens carrier defines a cylindrical structure including a number of receptacles disposed at a midpoint of the lens carrier. The number of receptacles are configured to hold a number of sensor assemblies therein. The sensor assemblies include a first sensor assembly and a second sensor assembly. The first sensor assembly includes a first sensor lens and a first sensor. The second sensor assembly includes a second sensor lens and a second sensor. The first sensor assembly is positioned proximate the second sensor assembly. The first sensor assembly is configured to emit a signal and the second sensor assembly is configured to receive the emitted signal. Positioned between the first sensor assembly and the second sensor assembly, and at least partially disposed around the first sensor assembly and the second sensor assembly, is a gasket. The gasket extends from a base of the first sensor and the second sensor to second face of the lens carrier. The gasket is configured to block an emitted signal from the first sensor assembly.

Another example embodiment relates to a sensor system for use in home devices and configured to transmit and receive a signal. The sensor system includes a housing and a lens carrier at least partially disposed within the housing. The lens carrier defines a cylindrical structure including a first face and a second face, and having a number of receptacles disposed at a midpoint of the lens carrier. The first face is defined to be a substantially smooth face and the second face includes an outer edge and an inner edge. The outer edge includes a number of mounting tabs extending perpendicular from the second face and configured to mount the lens carrier to the housing. The number of receptacles are configured to hold a number of sensor assemblies therein. The sensor assemblies include a first sensor assembly and a second sensor assembly. The first sensor assembly includes a first sensor lens and a first sensor. The second sensor assembly includes a second sensor lens and a second sensor. The first sensor assembly is positioned proximate the second sensor assembly. The first sensor assembly is configured to emit a signal and the second sensor assembly is configured to receive the emitted signal. Positioned between the first sensor assembly and the second sensor assembly, and at least partially disposed around the first sensor assembly and the second sensor assembly, is a gasket. The gasket extends from a base of the first sensor and the second sensor to second face of the lens carrier. The gasket is configured to block an emitted signal from the first sensor assembly.

Another example embodiment relates to a sensor system. The sensor system includes a housing and a lens carrier at least partially disposed within the housing. The lens carrier defines a cylindrical structure including a first face and a second face, and having a number of receptacles disposed at a midpoint of the lens carrier. The first face is defined to be a substantially smooth face and the second face includes an outer edge and an inner edge. The outer edge includes a number of mounting tabs extending perpendicular from the second face and configured to mount the lens carrier to the housing. The number of receptacles are configured to hold a number of sensor assemblies therein. The sensor assemblies include a first sensor assembly and a second sensor assembly. The first sensor assembly includes a first sensor lens and a first sensor. The second sensor assembly includes a second sensor lens and a second sensor. The first sensor assembly is positioned proximate the second sensor assembly. The first sensor assembly is configured to emit a signal into a first field of view and the second sensor assembly is configured to receive the emitted signal in a second field of view. Positioned between the first sensor assembly and the second sensor assembly, and at least partially disposed around the first sensor assembly and the second sensor assembly, is a gasket. The gasket extends from a base of the first sensor and the second sensor to second face of the lens carrier. The gasket is configured to block an emitted signal from the first sensor assembly. The first field of view is a field of view where the signal is emitted from the first sensor prior to reflecting off a target object. The second field of view is a field of view where the signal is received after reflecting off a target object.

Another example embodiment relates to a sensor system. The sensor system comprises a housing, a lens carrier having an outer face, the lens carrier including a first lens and a second lens coupled thereto, a first sensor comprising an emitter, the first sensor positioned in the housing, a second sensor comprising a receiver, the second sensor positioned in the housing and proximate the first sensor, a gasket at least partially disposed around each of the first sensor and the second sensor, a first portion of the gasket positioned between the first sensor and the second sensor, and a blocker element, wherein at least a portion of the blocker element is positioned between the first sensor and the second sensor. The lens carrier is coupleable to the housing such that lens carrier is at least partially disposed within the housing and the first lens is arranged over the first sensor and the second lens is arranged over the second sensor, the emitter is configured to emit an infrared signal through the first lens, such that the emitted infrared signal reflects off a target object and through the second lens and is received by the receiver, and the blocker element is configured to obstruct signal crosstalk between the first sensor and the second sensor.

Another example embodiment relates to a system. The system comprises an apparatus and a sensor arrangement. The sensor arrangement includes: a housing operably coupled to the apparatus, a lens carrier having an outer face, the lens carrier including a first lens and a second lens coupled thereto, a first sensor comprising an emitter, the first sensor positioned in the housing, a second sensor comprising a receiver, the second sensor positioned in the housing and proximate the first sensor, a gasket at least partially disposed around each of the first sensor and the second sensor, a first portion of the gasket positioned between the first sensor and the second sensor, and a blocker element, wherein at least a portion of the blocker element is positioned between the first sensor and the second sensor. The lens carrier is coupleable to the housing such that lens carrier is at least partially disposed within the housing and the first lens is arranged over the first sensor and the second lens is arranged over the second sensor, the blocker element is configured to obstruct signal crosstalk between the first sensor and the second sensor, and the emitter is configured to emit an infrared signal through the first lens, such that the emitted infrared signal reflects off a target object and through the second lens and is received by the receiver so as to effect operation of the apparatus.

Another example embodiment relates to a system. The system comprises a first sensor arrangement including a pair of infrared sensors, a second sensor arrangement including an emitter and a receiver, and a gasket operably coupled to at least the second sensor arrangement, the gasket configured to provide a mechanical blockage between the emitter and the receiver so as to limit signal crosstalk in the sensor system. The first sensor arrangement is maintained in an operable, powered-on state and wherein the second sensor arrangement is maintained in an unpowered sleep state, the sensor system configured to cause the second sensor arrangement to be switched to an operable, powered-on state in response to detection by the first sensor arrangement of presence of an object. The emitter is configured to emit an infrared signal, such that the emitted infrared signal reflects off the object and is received by the receiver so as to control operation of an apparatus associated with the sensor system.

This summary is illustrative only and should not be regarded as limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a sensor system, according to an example embodiment;

FIG. 2 is a perspective view of a lens carrier of the sensor system of FIG. 1, according to an example embodiment;

FIG. 3 is a front view of the lens carrier of FIG. 2 including lens, according to an example embodiment;

FIG. 4 is a rear view of the lens carrier of FIG. 2 including lens, according to an example embodiment;

FIG. 5 is a perspective view of a lens of the sensor system of FIG. 1, according to an example embodiment;

FIG. 6 is a detailed view of the sensor system of FIG. 1, according to an example embodiment.

FIG. 7 is a detailed side view of the sensor system of FIG. 1, according to an example embodiment;

FIG. 8 is a block diagram of a controller of the sensor system of FIG. 1, according to an example embodiment;

FIG. 9 is a diagram of a prior art sensor system with crosstalk, according to an example embodiment;

FIG. 10 is a diagram of a sensor system with crosstalk, according to an example embodiment;

FIG. 11 is a diagram of the sensor system of FIG. 1, according to an example embodiment; and

FIG. 12 is a top perspective view of a sensor system, according to another example embodiment.

FIG. 13 is a bottom perspective view of portions of the sensor system of FIG. 12.

FIG. 14 is a cross-sectional view of the sensor system of FIG. 12, taken across a lateral axis.

FIG. 15 is a cross-sectional view of the sensor system of FIG. 12, taken across a longitudinal axis.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Before turning to the FIGURES, which illustrate certain exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

Referring generally to the FIGURES, a sensor system 100 is disclosed according to various embodiments. The sensor system 100 is configured for use in a home environment, such as a bathroom or kitchen. The sensor system 100 may include at least one of a housing and a lens carrier positioned within the housing. The housing may encapsulate at least a portion of the lens carrier. One or more components of the sensor system 100 may be manufactured from an opaque material such to prevent the sensor system from transmitting a signal through the lens carrier. The lens carrier may have a first face and a second face, where the second face is positioned rearward the first face. The first face may be a substantially flat surface whereas the second face may include protrusions or recesses. The second face includes a number of protrusions or tabs extending perpendicular from the second face. The protrusions are configured to mount the lens carrier to the housing, where the protrusions may be recessed into a receiver. The protrusions may be radially positioned along an outer edge of the second face, where each protrusion is uniformly distanced between one another.

Coupled to the lens carrier is a number of lens. By way of example, the number of lens includes a first lens and a second lens. The first lens may be positioned proximate the second lens, where the first lens may be an emitting lens and the second lens may be a receiving lens. The first lens may be substantially similar to the second lens such that the first lens may be a receiving lens and the second lens may be an emitting lens. The first lens and the second lens may include tabs or flanges extending radially outward from the first lens and the second lens. The flanges may be configured to be locating flanges, where the flanges are placed into a groove on the second face to couple the first lens and the second lens to the lens carrier.

Positioned rearward the lens carrier, aligned with the first lens and the second lens, may be a number of sensors. The number of sensors includes a first sensor and a second sensor. The first sensor may be an emitting sensor and the second sensor may be a receiving sensor. The first sensor may be configured to emit an infrared signal through the first lens, where the infrared light reflects off a target object through the second lens and is received by the second sensor.

Positioned between the first sensor and the second sensor and the lens carrier, and at least partially disposed around the first sensor and the second sensor, is a gasket. The gasket may be manufactured out of an elastomeric material. The gasket may provide as a mechanical feature to at least prevent infrared signals from transmitting across the lens carrier causing signal crosstalk. Positioned between the first sensor and the second sensor is a blocker. The blocker may include a portion positioned between the first sensor and the second sensor, where the blocker extends a distance past the lens carrier. The blocker may be configured to obstruct signal crosstalk by providing a mechanical blockage between the first sensor and the second sensor. By way of example, the blocker may be a combination of a portion of the gasket and a portion of the lens carrier. The portion of the gasket may be the portion between the first sensor and the second sensor and the portion of the lens carrier may be a portion between the first sensor and the second sensor.

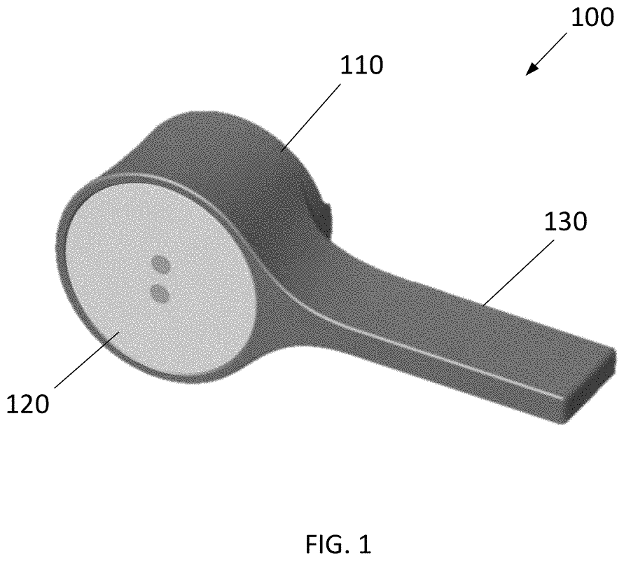

Referring to FIG. 1, a sensor system 100 is shown, according to an example embodiment. The sensor system 100 may be configured for use on faucets, kitchen appliances, bathroom appliances, or showerheads (e.g., faucet, toilet, dishwasher, showerhead, etc.). The sensor system 100 may include a housing 110 and a lens carrier 120 disposed within the housing 110. The housing 110 may be a circular structure extending around at least a portion of a perimeter of the lens carrier 120. In some embodiments, the housing 110 may be of any geometrical configuration (e.g., square, prismatic, triangular, etc.), where the housing at least partially encapsulates the lens carrier 120. In some embodiments, the housing 110 may entirely encapsulate the lens carrier 120. The housing 110 may include a generally elongate structure, shown as housing flange 130. The housing flange 130 may extend radially outward from the housing 110. One or more components of the sensor system 100 may be manufactured out of an opaque material (e.g., plastic, composite, metal, etc.) such to prevent the sensor system 100 from transmitting a signal through the lens carrier 120. In some embodiments, one or more components of the sensor system 100 may be manufactured out of a material that may be at least partially translucent.

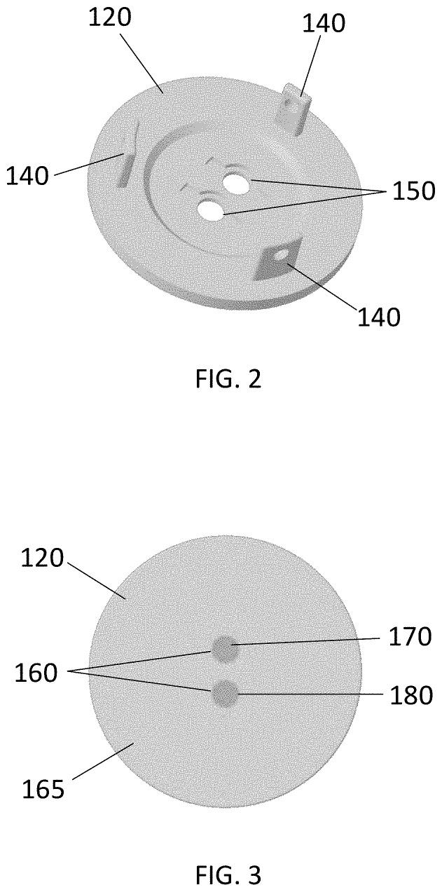

Referring now to FIG. 2, a perspective, rear view of the lens carrier 120 is shown. The lens carrier 120 may include a number of mounting tabs 140. The mounting tabs 140 may be positioned along an outer radius of the lens carrier 120, where the mounting tabs 140 are positioned equidistant to one another (e.g., equal distance between each of the mounting tabs 140). As shown in FIG. 2, the lens carrier 120 includes three mounting tabs 140 positioned along the outer radius and extending generally perpendicular from a face of the lens carrier 120. In some embodiments, the lens carrier 120 may have at least one mounting tab 140 positioned on a face of the lens carrier 120. The mounting tabs 140 may be configured to couple the lens carrier to the housing 110. To be more precise, the mounting tabs 140 are selectively coupled to the housing 110 by sliding the lens carrier 120 between an engaged position and a disengaged position. By way of example, the mounting tabs 140 may be locking tabs, barbed flanges, or any similar locking mechanism. Positioned inward the mounting tabs 140 may be a number of lens receptacles 150. The lens receptacles 150 may be centrally located on the face of the lens carrier 120. To be more precise, the lens receptacles 150 may be located proximate a midpoint of the lens carrier 120. The lens receptacles 150 may be configured to receive a lens or infrared-transmitting lens, shown as lenses 160 in FIG. 3. The lens receptacle 150 may be of a substantially similar geometry of the lenses 160 so that the lenses 160 may seat entirely within the lens receptacle 150.

Referring now to FIGS. 3-5, a front view of the lens carrier 120 is shown. The lens carrier 120 includes a first face 165, where the first face 165 may be a substantially flat surface. In some embodiments, the first face 165 may include ribs, protrusions, curved features, or other defining features. Disposed through the lens carrier 120 may be lenses 160. The lenses 160 may include a first lens 170 and a second lens 180. The second lens 180 may be positioned proximate the first lens 170. In some embodiments, the second lens 180 may be positioned distal the first lens 170. By way of example, the first lens 170 and the second lens 180 may be one of an emitter and a receiver. To be more precise, the first lens 170 may be positioned on top of an infrared emitter configured to emit photons and the second lens 180 may be positioned on top of an infrared receiver configured to receive the emitted photons once they have reflected off of their desired target.

Referring still to FIGS. 3-5, the lenses 160 may include a number of tabs shown as lens flanges 190. The lens flanges 190 may be components configured to assist in molding of the lenses 160. In some embodiments, the lens flanges 190 may be positioned adjacent one another. Positioned between the lens flanges 190 is a face, shown as lens face 200. The lens face 200 may comprise a substantially circular face configured to facilitate emitting and receiving a signal.

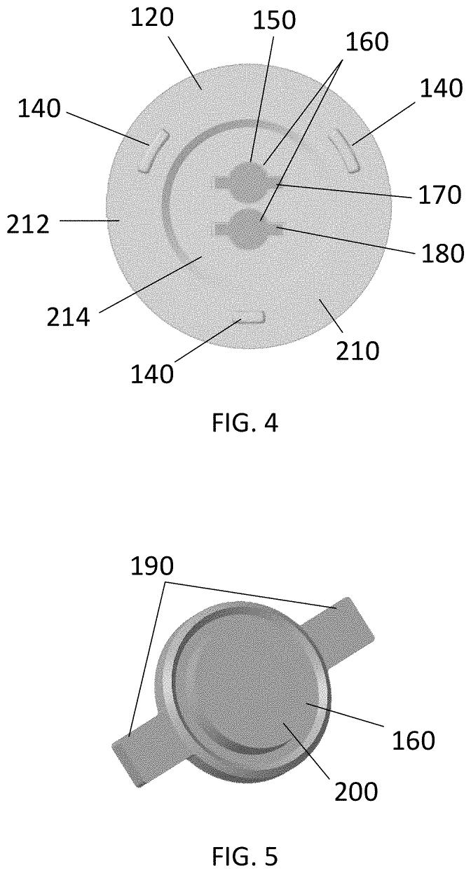

The lens carrier 120 includes a second face 210, positioned opposite the first face 165 (shown in FIG. 4). The second face 210 includes an outer portion 212 and an inner portion 214, where the inner portion 214 is positioned adjacent the outer portion 212. By way of example, the mounting tabs 140 may be coupled to the outer portion 212 and the lens housings 150 may be coupled to the inner portion 214. In some embodiments, the mounting tabs 140 may be coupled to the inner portion 214 and the lens housings 150 may be coupled to the outer portion 212. The inner portion 214 may be recessed surface so that the inner portion 214 may be a cavity of which the lenses 160 are disposed.

The lenses 160 may be coupled to the lens carrier 120 using ultrasonic welding. That is, the lenses 160 are ultrasonically welded into the lens carrier 120 on a rearward face of the lenses 160. Ultrasonic welding is used to prevent contamination or damage to the sealing surfaces. In some embodiments, alternate methods such as adhesive, fasteners, or the like, may be used to couple the lenses 160 to the lens carrier 120.

The first face 165 of lens carrier 120 may be substantially similar to the second face 210. That is, both the first face 165 and the second face 210 may define generally circular structures. In some embodiments, the first face 165 and the second face 210 may define any geometrical configuration that facilitates in emitting and receiving a signal (e.g., cylindrical, triangular, prismatic, etc.).

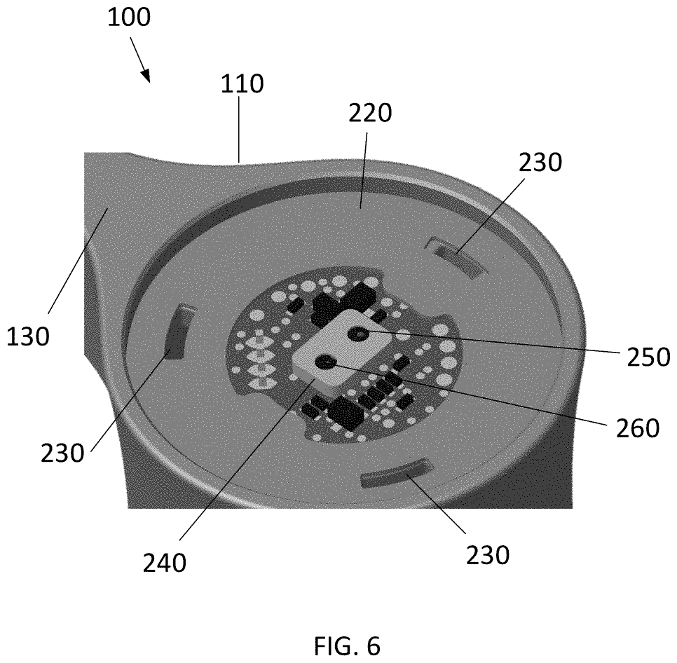

Referring to FIG. 6, a detailed view of some components of the sensor system 100 is shown, with lens carrier 120 removed for clarity. The sensor system 100 further includes a receiving component, shown as seal 220. The seal 220 may be configured to receive the lens carrier 120 to couple the lens carrier 120 to the sensor system 100. The seal 220 may be further configured to seal the housing 110 (shown in FIG. 1) such to prevent material (e.g., water, fluid, etc.) from entering within the housing 110 (shown in FIG. 1). Seal 220 may cover a printed circuit board in whole or in part, with sensors 250 and 260 mounted to or otherwise coupled with the printed circuit board. The seal 220 may include a number of receiving portions, shown as tab receivers 230. The tab receivers 230 may be positioned proximate an outer edge of the seal 220 so that the mounting tabs 140 may be disposed within the tab receivers 230 when the lens carrier 120 is coupled to the sensor system 100. By way of example, the number of tab receivers 230 may be equal to the number of mounting tabs 140. In some embodiments, there may be more tab receivers 230 than mounting tabs 140 such to allow for various alignment configurations.

Referring still to FIG. 6, positioned centrally within the sensor system 100 is a gasket, spacer, washer, covering, or seal, shown as gasket 240. The gasket 240 may be positioned between a number of sensors, shown as emitter 250 and receiver 260, and the lens carrier 120 (e.g., shown in FIG. 1). The gasket 240 may be configured to absorb condensation, moisture, liquid, or the like so that a material (e.g., water, liquid etc.) does not fog at least one of the first lens 170 and the second lens 180. The gasket 240 may be manufactured out of an elastomeric material (e.g., any material exhibiting rubber-like properties) such to provide a degree of resilience. In some embodiments, the gasket 240 may be manufactured out of a felt material. In still some embodiments, the gasket 240 may be configured to act as a barrier to prevent material (e.g., water, liquid, etc.) from entering into the sensor system 100.

The gasket 240 may include a number of apertures of which the emitter 250 and the receiver 260 may be disposed within. By way of example, the emitter 250 may be configured to emit an infrared light and the receiver 260 may be configured to receive the infrared light emitted from the first sensor. In some embodiments, the emitter 250 and the receiver 260 may be a single sensor, where the single sensor includes at least one of an emitter and a receiver. In such an embodiment, the single sensor may include a dividing portion positioned between the emitter and the receiver. The gasket 240 may further be configured to eliminate crosstalk by preventing light, emitted from the emitter 250, from bouncing to the receiver 260. To be more precise, the gasket 240 may be configured to prevent light from reflecting off components disposed within an internal cavity of the sensor system and being received by the second sensor causing a false reading.

Referring still to FIG. 6, the gasket 240 may be a shell structure with the emitter 250 and the receiver 260 contained therein. The gasket 240 may include a number of sidewalls extending in a direction perpendicular from the first face 165, where the number of sidewalls extend past the emitter 250 and the receiver 260. That is, the number of sidewalls include four sidewalls configured to circumferentially surround the emitter 250 and the receiver 260. In some embodiments, the number of sidewalls includes a bottom wall positioned rearward at least one of the emitter 250 and the receiver 260. The shell structure further includes a set of apertures positioned between the emitter 250 and the lens carrier 120, and between the receiver 260 and the lens carrier 120. The set of apertures may be configured to allow infrared light to pass through, from or to, at least one of the emitter 250 and the receiver 260. The gasket 240 may include an additional flange. The additional flange may be configured to (a) assist the gasket 240 with alignment during assembly or (b) prevent light from transmitting within the housing (housing 110 in FIG. 1).

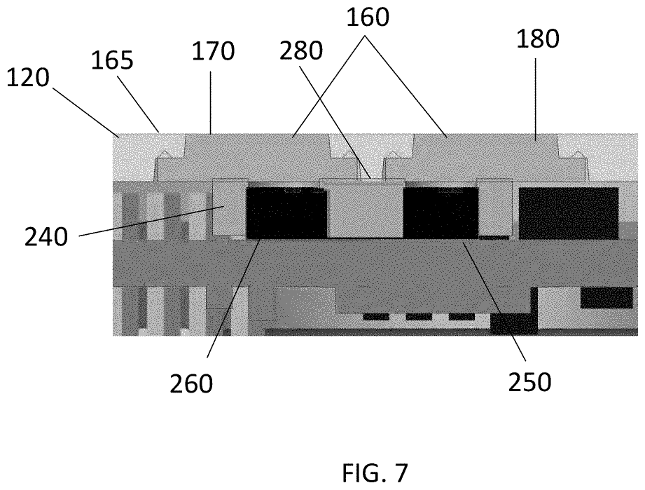

Signal crosstalk, as traditionally presented, is the unwanted transfer of signals between communication devices (e.g., sensors, channels, etc.). That is, signal crosstalk is the transfer of signals from an emitting device, where the signal was reflected back to a receiver prior to reflecting off of a target object, therefore presenting a false reading. Signal crosstalk is commonly known to present a false reading in applications where there is significant open space where a false signal may transmit through. Referring now to FIGS. 6 and 7, the lenses 160 are shown as seated flush with the first face 165 (shown in FIG. 7). In some embodiments, the lenses 160 may be recessed into the lens carrier 120. In still some embodiments, the lenses 160 may be positioned external the lens carrier 120 to form a number of outer protrusions.

As shown in FIG. 7, the gasket 240 may be at least partially configured as a divider or blocker such to prevent light from incidentally being reflected into the receiver 260 prior to reflecting off of the target object. To be more precise, the sensor system 100 includes a mechanical blocker or divider, shown as blocker 280. In an embodiment, the blocker 280 may be a multilayer blocker comprising a top layer and a bottom layer. The top layer may be a portion of the lens carrier 120 between the lenses 160. The bottom later may be a portion of the gasket 240 between the emitter 250 and the receiver 260. In some embodiments, the blocker 280 may be comprised only of the gasket 240. In still some embodiments, the blocker 280 may be comprised only of the lens carrier 120. In an embodiment the gasket 240 may have a portion positioned between the emitter 250 and the receiver 260, where the gasket 240 extends a length of the sensor system 100 such to abut the lenses 160. In another embodiment, the gasket 240 may extend a portion of the length of the sensor system 100 so that the gasket 240 does not abut the lenses 160, but rather gasket 240 may extend outward to abut lens carrier 120. The portion of the gasket 240 positioned between the emitter 250 and the receiver 260 may be the divider or blocker between the emitter 250 and the receiver 260. As can be appreciated, the portion of the gasket 240 between the emitter 250 and the receiver 260 may prevent infrared light from falsely transmitting between the emitter 250 and the receiver 260, thus preventing signal crosstalk within the sensor system 100.

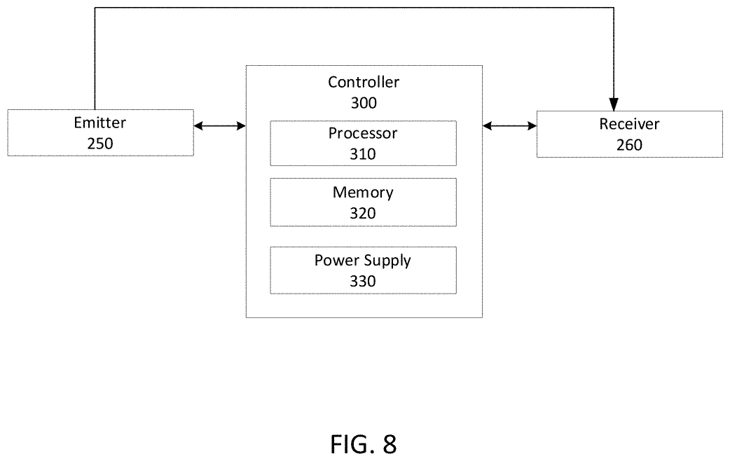

Referring now to FIG. 8, a block diagram of a control system of the sensor system 100 is shown. The sensor system 100 includes controller 300 operably coupled to the emitter 250 and the receiver 260. The controller 300 may be positioned proximate the lens carrier 120, seal 220, housing 110, or any combination thereof. Specifically, the controller 300 includes a processor 310, a memory 320, and a power supply 330. The control system of the sensor system 100 may further be integrated into a single circuit system.

Referring still to FIG. 8, the memory 320 may store machine instructions that, when executed by the processor 310, cause the processor 310 to perform one or more of computer operations. The processor 310 may include one or more microprocessors, application specific integrated circuits (ASICs), field programmable gate arrays (FPGAs), other forms of processing circuits, or combinations thereof. The memory 320 may include, but is not limited to, electronic, optical, magnetic, or any other storage or transmission device capable of providing the processor 310 with program instructions. The memory 320 may include storage devices such as a floppy disk, CD-ROM, DVD, magnetic disk, memory chip, ROM, RAM, EEPROM, EPROM, flash memory, optical media, or any other suitable memory from which the processor 310 can read instructions and/or data. The processor 310 and the memory 320 may form a processing module.

Referring still to FIG. 8, the power supply 330 is operatively coupled to the emitter 250, the receiver 260, and the controller 300. The power supply 330 may be a central power supply positioned within the sensor system 100. In some embodiments, the power supply 330 is decentralized such that a portion of the power supply 330 lies with the emitter 250 and a portion of the power supply 330 lies within the receiver 260. The power supply 330 may be coupled to a power source external to the sensor system 100 (e.g., utility power, wall charger, 120V AC, etc.). In some embodiments, the power supply 330 is removable from the sensor system 100 such that a power cell (e.g., disposable batteries) may be replaced and the power supply 330 re-attached to the sensor system 100.

Referring still to FIG. 8, the controller 300 may be configured to calculate the distance from sensor system 100 to a target object based on time. To be more precise, the controller may calculate the amount of time an infrared light beam takes to emit from the first lens 170, reflect off the target object, and receive into the second lens 180. From this time data, the processor 310 may calculate the distance from the sensor system 100 to the target object.

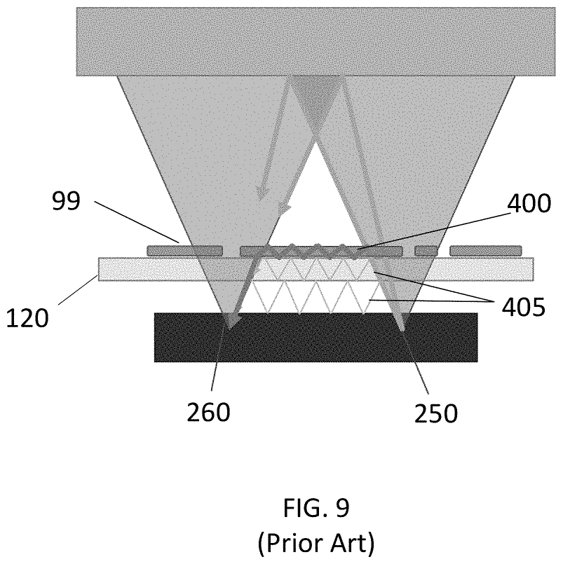

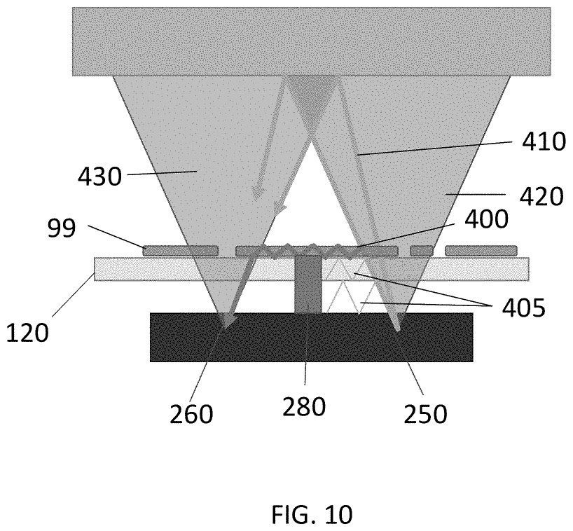

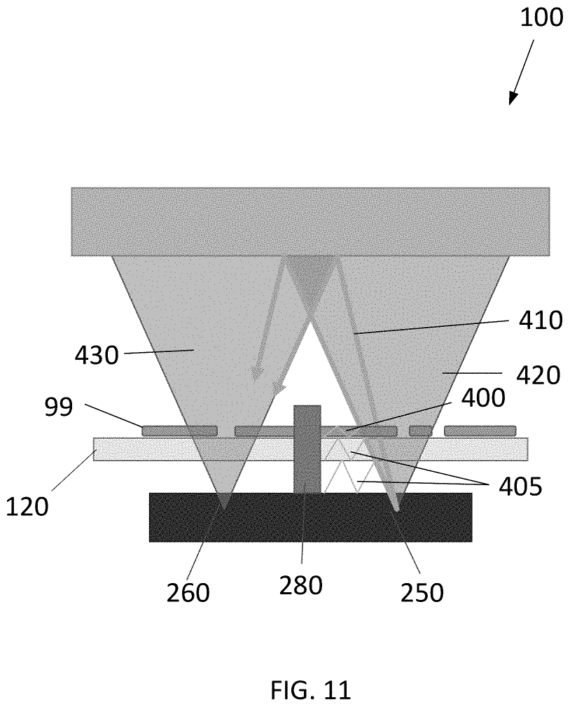

Signal crosstalk, as illustrated in FIG. 9, is commonly routed along a direction, shown as crosstalk direction 400 through condensation droplets 99. Subsequently, signal crosstalk also includes a number of compensated rays that are commonly routed along a secondary direction, shown as compensated crosstalk direction 405 through lens carrier 120. By way of example, the compensated rays may be positioned between the first face 165 of lens carrier 120 and at least one of the emitter 250 and the receiver 260. Due to the absence of a signal blocker, gasket, or the like, the emitted infrared light from the emitter 250 is able to translate to the receiver 260 prior to reflecting off of the target object, giving the receiving sensor a false reading. By way of example, crosstalk causes false readings by sensors promoting a component to prematurely actuate. In some embodiments, crosstalk may be a consistent signal thus promoting the component to maintain in an “on” position. As shown in FIGS. 10 and 11, with the inclusion of the gasket 240, the crosstalk direction 400 may be at least partially obstructed before the signal reaches the receiver 260. The infrared light is able to be emitted from the emitter 250 along a direction, shown as second direction 410, where the infrared light may reflect off of the target object.

Referring still to FIGS. 10 and 11, the emitter 250 includes a first field of view 420 and the receiver 260 may include a second field of view 430. By way of example, the first field of view 420 may be a field of view where the infrared light may be emitted, and the second field of view 430 may be a field of view where the receiver 260 may receive the emitted infrared light. The first field of view 420 and the second field of view 430 may overlap one another at a distance away from the lenses 160. The size of the overlap region may vary based on the distance from the lenses 160 to the target object. For example, the farther away the target object is from the lenses 160, the larger the overlap area. As can be appreciated, second direction 410 may be any direction disposed within the first field of view 420 and the second field of view 430.

Referring specifically to FIG. 10, a diagram of the sensor system 100 is shown when the blocker 280 may extend up to the lens carrier 120. When the blocker 280 extends up to the lens carrier 120, the blocker 280 does not protrude up to, or extend past, the first face 165. According to an example embodiment, when the blocker 280 does not extend past the first face 165, signal crosstalk may still occur along crosstalk direction 400. Although, in such an embodiment, the blocker 280 provides sufficient mechanical blockage of the compensated rays along compensated crosstalk direction 405. Further, the use of an opaque material for lens carrier 120, as taught by the present disclosure, will limit or prevent signal crosstalk along direction 400. In some embodiments, the blocker 280 may prevent signal crosstalk when the blocker 280 does not extend past the first face 165.

Referring still to FIG. 10, even if the blocker 280 were to extend through the lens carrier 120 and terminate at the first face 165 (i.e., the distal end of the blocker 280 is coplanar with the first face 165), crosstalk could still occur in some implementations. For example, when implemented in kitchen or bathroom applications, condensation may gather on the first face 165, creating a thin layer of water or water droplets that may provide an additional crosstalk path. Accordingly, even with the blocker 280 present, but not extending past the first face 165, some signal crosstalk may still occur, where the presence of condensation may make the signal crosstalk more severe.

In some embodiments, blocker 280 may be positioned such that at least a portion of the blocker 280 extends a distance past the first face 165. Referring specifically to FIG. 11, although not shown, the blocker 280 may be positioned so that an outer face of the blocker 280 may sit flush with the first face 165. That is, the outer face of the blocker 280 may be smooth with the first face 165 such to provide a more aesthetically pleasing structure. In some embodiments, at least a portion of the blocker 280 may extend a distance from the first face 165, the distance being a substantial distance to obstruct the signal crosstalk (e.g., extending past a thickness of condensation or water droplets). In still some embodiments, the distance from the first face 165 may be equivalent to a width of the blocker 280. In still some embodiments, the distance from the first face 165 may be less than a width of the blocker 280. In still some embodiments, the blocker 280 may be a distance equivalent to a length of the blocker 280, where a midpoint of the blocker 280 is at the first face 165. In still some embodiments, the blocker 280 may not extend past the gasket 240. As shown in FIG. 11, with the blocker 280 extending past the first face 165, condensation positioned on the first face 165 may not facilitate signal crosstalk due to the presence of the blocker 280. Although not shown in FIG. 11, inadvertently with the gasket 240 positioned at least partially around the emitter 250 and the receiver 260, signal crosstalk may be prevented from occurring within components positioned rearward the emitter 250 and the receiver 260 due to the components being encapsulated within gasket 240.

Referring still to FIG. 11, the sensor system 100 may be configured to emit and receive an infrared without signal crosstalk interference. The blocker 280 extends past the lens carrier 120 thus preventing the signal crosstalk from providing the receiver 260 with a false reading. As can be appreciated, the emitter 250 may emit a signal into the first field of view 420 where the signal is reflected off of the target object into the second field of view 430 and received by the receiver 260. In such an embodiment, signal crosstalk does not reach the receiver 260 with the blocker 280 obstructing the signal crosstalk prior to the receiver 260. By way of example, the sensor system 100 may only detect objects within a maximum field of view. To be more precise, the sensor system 100 may detect objects that are within 4 inches from the sensor system 100 such to eliminate condensation or steam from triggering a false detection. In some embodiments, the sensor system 100 may detect objects further than 4 inches from the sensor system 100.

According to an exemplary embodiment, the first lenses 160 and the second lens 170 may be a single lens positioned over top of both the emitter 250 and the receiver 260. In such an embodiment, the single lens may include a dividing window. The dividing window may extend substantially perpendicular from the lens carrier 120 such to eliminate signal crosstalk between the emitter 250 and the receiver 260.

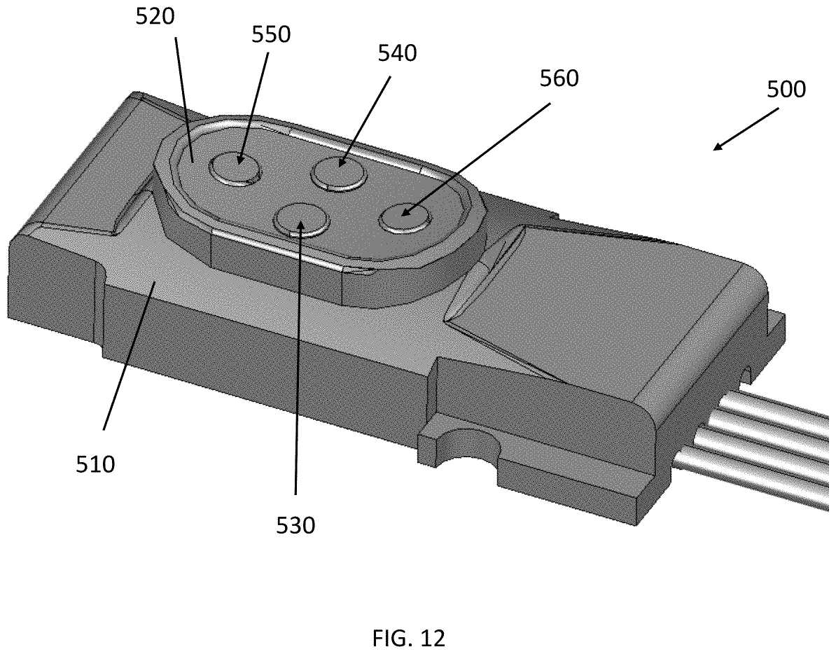

According to an example embodiment shown in FIGS. 12-15, a sensor system 500 is shown. The sensor system 500 includes a housing disposed around at least an outer portion of the sensor system 500 and a lens carrier 520 positioned on a side of the housing 510. The lens carrier 520 may be a circular structure positioned along a central axis of the housing 510 (e.g., midpoint, etc.). In some embodiments, the lens carrier 520 may be configured to be any combination of geometrical configurations.

Referring still to FIG. 12, the sensor system 500 includes a number of sensors, shown as emitter 530, receiver 540, first infrared sensor 550, and second infrared sensor 560, positioned along the lens carrier 520. The number of sensors 530, 540, 550, 560 may be positioned proximate one another within the lens carrier 520. In some embodiments, the number of sensors 530, 540, 550, and 560 may be positioned distal one another within the lens carrier 520. The emitter 530 may be configured to emit an infrared signal from the sensor system 500 directed in the direction of a target object. The receiver 540 may be configured to receive the signal emitted from the emitter 530, where the receiver 540 may communicate back to the sensor system 500. The first infrared sensor 550 and the second infrared sensor 560 may be active infrared sensors configured to consume less power than either the emitter 530 or the receiver 540. The first infrared sensor 550 and the second infrared sensor 560 may be configured to cause the emitter 530 and the receiver 540 to turn on (e.g., be supplied with electrical power) when the first infrared sensor 550 and the second infrared sensor 560 detect the presence of an object, so as to advantageously reduce the amount of electrical power needed to operate sensor system 500. The reduced power demand of sensor arrangement 500 may allow sensor system 500 to be operated with a battery (single use or rechargeable), thereby simplifying installation of sensor system 500 and any associated components. The supply of power to emitter 530 and receiver 540 may be terminated at a predetermined time following removal of the object, for example after five seconds. Although not depicted in the Figures, sensor system 500 includes appropriate switching components for activating and deactivating emitter 530 and receiver 540.

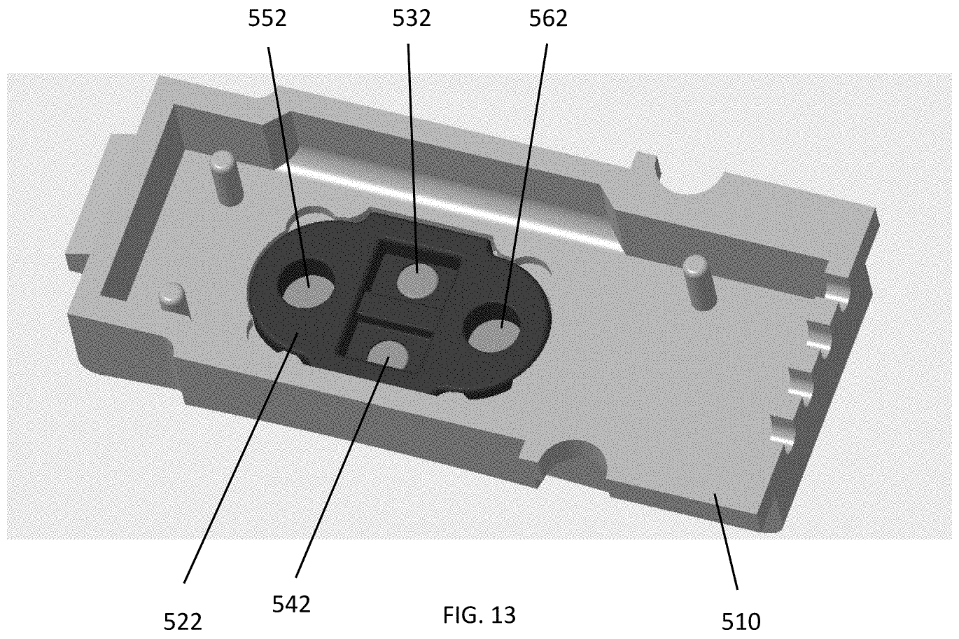

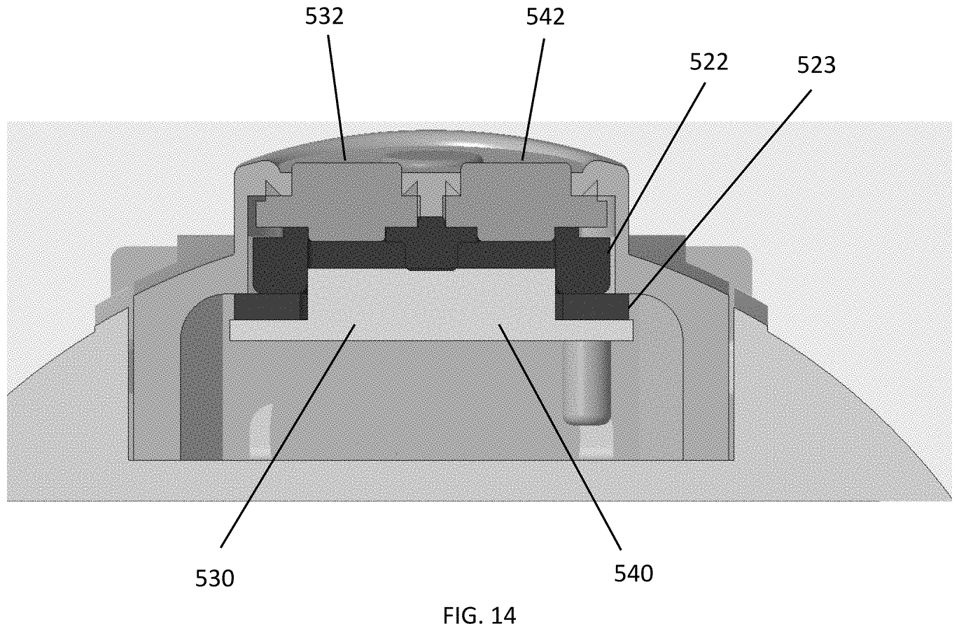

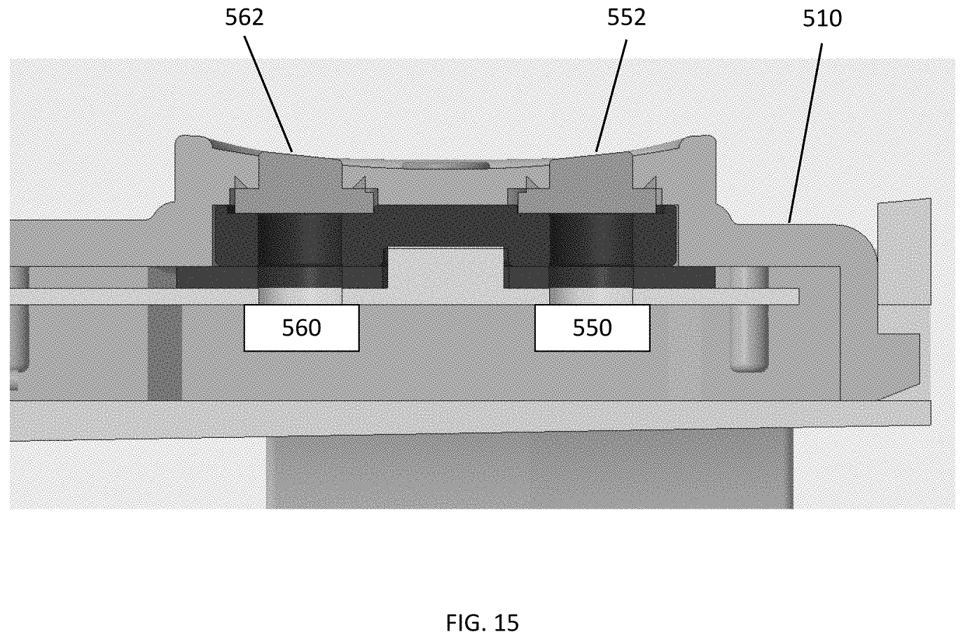

Referring to FIGS. 13-15, sensor system 500 includes a gasket 522, surrounding lenses 532, 542, 552 and 562, with gasket 522 being functionally similar to gasket 240 described previously. Each of lenses 532, 542, 552, and 562 are configured to be arranged over sensors 530, 540, 550, and 560, respectively, with corresponding apertures in gasket 522 as generally depicted in the Figures. Sensor system 500 may also include a seal 523, as best depicted in FIGS. 14-15.

Sensor system 500 provides improvements to crosstalk reduction similar to sensor system 100, due to similarities in construction and material selection. Sensor system 500 advantageously includes IR sensors 550 and 560 operable to selectively supply power to emitter 530 and receiver 540, for improved operability under battery power.

Although embodiments described herein may be configured for use in a home or residential environment, such description should be considered exemplary rather than limiting, and it will be understood the embodiments described herein may also be used in commercial environments, governmental environments, manufacturing environments, health care environments, or other such settings.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. For example, the sensor system 100 of the exemplary embodiment described in at least FIGS. 1-7 may be incorporated with the sensor system of the exemplary embodiment described in at least FIG. 9. As another example, the sensor system 100 of the exemplary embodiment described in at least FIGS. 1-7 may be incorporated into the sensor system of the exemplary embodiment described in at least FIG. 10. Although only two examples of an element from one embodiment that can be incorporated or utilized in another embodiment has been described above, it should be appreciated that other elements of the various embodiments may be incorporated or utilized with any of the other embodiments disclosed herein.

1. A sensor system, comprising:
a housing;
a lens carrier having an outer face, the lens carrier including a first lens and a second lens coupled thereto;
a first sensor comprising an emitter, the first sensor positioned in the housing;
a second sensor comprising a receiver, the second sensor positioned in the housing and proximate the first sensor;
a gasket at least partially disposed around each of the first sensor and the second sensor, a first portion of the gasket positioned between the first sensor and the second sensor; and
a blocker element, wherein at least a portion of the blocker element is positioned between the first sensor and the second sensor,
wherein the lens carrier is coupleable to the housing such that the lens carrier is at least partially disposed within the housing and the first lens is arranged over the first sensor and the second lens is arranged over the second sensor,
wherein the emitter is configured to emit an infrared signal through the first lens, such that the emitted infrared signal reflects off a target object and through the second lens and is received by the receiver, and
wherein the blocker element is configured to obstruct signal crosstalk between the first sensor and the second sensor.

2. The sensor system of claim 1, wherein the portion of the gasket positioned between the first sensor and the second sensor comprises the blocker element.

3. The sensor system of claim 1, wherein the blocker element is multilayer including:
a top layer comprising a portion of the lens carrier arranged between the first lens and the second lens; and
a bottom layer comprising the portion of the gasket positioned between the first sensor and the second sensor.

4. The sensor system of claim 1, wherein the lens carrier is constructed from an opaque material.

5. The sensor system of claim 1, wherein the blocker element extends beyond an outer face of the lens carrier.

6. The sensor system of claim 1, the gasket comprising a shell structure configured to contain the first sensor and the second sensor therein, the gasket including a first aperture aligned with the first sensor and a second aperture aligned with the second sensor.

7. A system, comprising:
an apparatus; and
a sensor arrangement, including:
a housing operably coupled to the apparatus;
a lens carrier having an outer face, the lens carrier including a first lens and a second lens coupled thereto;
a first sensor comprising an emitter, the first sensor positioned in the housing;
a second sensor comprising a receiver, the second sensor positioned in the housing and proximate the first sensor;
a gasket at least partially disposed around each of the first sensor and the second sensor, a first portion of the gasket positioned between the first sensor and the second sensor; and
a blocker element, wherein at least a portion of the blocker element is positioned between the first sensor and the second sensor,
wherein the lens carrier is coupleable to the housing such that the lens carrier is at least partially disposed within the housing and the first lens is arranged over the first sensor and the second lens is arranged over the second sensor,
wherein the blocker element is configured to obstruct signal crosstalk between the first sensor and the second sensor,
wherein the emitter is configured to emit an infrared signal through the first lens, such that the emitted infrared signal reflects off a target object and through the second lens and is received by the receiver so as to effect operation of the apparatus.

8. The system of claim 7, wherein the apparatus comprises a faucet.

9. The system of claim 7, wherein the apparatus is operable when the target object is introduced within about four inches of the sensor arrangement.

10. The system of claim 7, wherein the portion of the gasket in the sensor arrangement positioned between the first sensor and the second sensor comprises the blocker element.

11. The system of claim 7, wherein the blocker element in the sensor arrangement is multilayer including:
a top layer comprising a portion of the lens carrier arranged between the first lens and the second lens; and
a bottom layer comprising the portion of the gasket positioned between the first sensor and the second sensor.

12. The system of claim 7, wherein the lens carrier in the sensor arrangement is constructed from an opaque material.

13. The system of claim 7, wherein the blocker element in the sensor arrangement extends beyond an outer face of the lens carrier.

14. A sensor system comprising:
a first sensor arrangement including a pair of infrared sensors;
a second sensor arrangement including an emitter and a receiver; and
a gasket operably coupled to at least the second sensor arrangement, the gasket configured to provide a mechanical blockage between the emitter and the receiver so as to limit signal crosstalk in the sensor system,
wherein the first sensor arrangement is maintained in an operable, powered-on state and wherein the second sensor arrangement is maintained in an unpowered sleep state, the sensor system configured to cause the second sensor arrangement to be switched to an operable, powered-on state in response to detection by the first sensor arrangement of presence of an object,
wherein the emitter is configured to emit an infrared signal, such that the emitted infrared signal reflects off the object and is received by the receiver so as to control operation of an apparatus associated with the sensor system.

15. The sensor system of claim 14, further comprising:
a housing; and
a lens carrier having an outer face, and first, second, third and fourth lenses, the lens carrier coupleable to the housing such that the lens carrier is at least partially disposed within the housing and such that the first and second lenses are arranged over the infrared sensors, the third lens is arranged over the emitter and the fourth lens is arranged over the receiver,
wherein the emitter is configured to emit an infrared signal through the third lens, such that the emitted infrared signal reflects off a target object and through the fourth lens and is received by the receiver.

16. The sensor system of claim 14, further comprising:
a blocker element, including:
a top layer comprising a portion of the lens carrier arranged between the third lens and the fourth lens; and
a bottom layer comprising the portion of the gasket positioned between the emitter and the receiver.

17. The sensor system of claim 14, wherein the lens carrier is constructed from an opaque material.

18. The sensor system of claim 14, wherein the sensor system is further configured to cause the second sensor arrangement to be switched back to the unpowered sleep state after a predetermined amount of time in response to removal of the presence of the object.

19. The system of claim 14, wherein the apparatus comprises a faucet.

20. The sensor system of claim 14, further including a power source comprising a battery.
